(19) United States
(12) Patent Application Publication
(10) Pub. No.: US 2008/0258931 A1
(43) Pub. Date: Oct. 23, 2008

(54) PNEUMATICALLY TELESCOPING MAST WITH DUAL MODE REMOTE CONTROL

(76) Inventors: Jerry Albert Christensen, Wooster, OH (US); Michael Allen Bohurjak, Medina, OH (US)

Correspondence Address: FAY SHARPE LLP, 1100 SUPERIOR AVENUE, SEVENTH FLOOR, CLEVELAND, OH, 44114, US

(21) Appl. No.: 12/104,696

(22) Filed: Apr. 17, 2008

Related U.S. Application Data
(60) Provisional application No. 60/923,956, filed on Apr. 17, 2007.

(51) Int. Cl. G08C 19/16

(52) U.S. Cl. 340/825.69

(57) ABSTRACT

A dual mode handheld remote control for selectively operating and communicating with an associated mast arrangement in one of a wired or a wireless mode is provided. The remote control includes a housing and a controller disposed internally to the housing. The controller includes a wireless communication mode for wirelessly communicating with the mast arrangement and a wired communication mode for communicating with the mast arrangement via a wired connection. An input device is secured to the housing and is operatively connected to the controller. The input device is responsive to an associated command selected by an associated operator and relays the associated command to the controller for controlling the associated mast arrangement. A power source is provided for powering the remote control.

A claim for domestic priority is made herein under 35 U.S.C. §119(e) to U.S. Provisional App. Ser. No. 60/923,956 filed on Apr. 17, 2007, the entire disclosure of which is incorporated herein by reference.

### BACKGROUND INFORMATION

Extendable mast arrangements generally have an extendable mast articulable about a base that is supported on a mobile vehicle. At the end of the mast opposite the base is at least one accessory, such as a light source. The accessory may also be adjustable in some manner. For example, the light source may have high output and low output settings. Furthermore, the light source may be rotatable about the mast and/or pivotable about an axis perpendicular to the mast. As a result, the mast arrangement will have a wide variety of movements and functions that should be responsive to the commands of an operator to maximize the utility of the mast arrangement.

The prior art pneumatically telescoping masts are extended using air, under pressure, and in a fully extended position, are generally vertical. A pneumatically telescoping mast typically includes a compressor or other pneumatic control means which displaces telescoping mast sections between retracted and extended positions. Additionally, a pneumatically telescoping mast may also include a mechanism for pivoting the mast between horizontal and vertical positions.

Commonly assigned U.S. Pat. Nos. 6,290,377, 5,980,070, 5,743,635, 6,299,336, 6,582,105, 6,584,105, and 7,062,221 are each incorporated herein by reference so that pneumatically actuated telescoping masts known in the art need not be described in detail hereinafter.

Previously, extendable mast arrangements of the foregoing character have provided an operator interface for the input of movement and function commands. Often the interface is in the form of a control panel or control pad located within the vehicle or attachable to the base of the mast adjacent the outside of the vehicle. This type of interface communicated electrical command signals directly to the control system of the mast arrangement. These electrical command signals are utilized by the mast arrangement to cause the extension or retraction of the mast, to cause the mast to pivot about the base, to cause the light source to turn on and off, and/or to cause the light source to pan about the mast or tilt about the axis perpendicular to the mast.

One problem with the above-described arrangement is that the control system of the mast arrangement must directly communicate electrical command signals to the mast accessory at the elevated end of the mast. As such, a separate wire for each function or movement of the accessory must extend from the base to the accessory at the elevated end of the mast. For an accessory having multiple functions and a variety of movements, a substantial number of wires may be required to transmit all of the command signals from the base to the accessory. This can add a significant amount of weight to the mast. Even though this additional weight is distributed along the entire length of the mast, the contribution of the portion of the wires extending along the accessory end of the mast places a significant additional load on the entire mast arrangement. Accordingly, it would be beneficial to minimize the wires extending from the base to the mast accessory.

Another problem with the previously discussed arrangement is that the control panel in the vehicle and the control pad attached to the outside of the vehicle each limit the mobility of the operator when deploying or adjusting the position of the mast and accessory. When utilizing the control panel, the operator must be in or at least reach into a compartment of the vehicle. This often makes it difficult to see the orientation of the mast and accessory, complicating deployment and directional adjustment. Utilizing the control pad attached to the base outside the vehicle improves the operator's ability to view the deployment of the mast and the directional positioning of the accessory supported thereon. However, the operator's range of mobility is limited by the length of the cord extending between the control pad and the base. Furthermore, the cord cannot be too long because it can become easily damaged and also presents a safety hazard should it be extended across an emergency or construction site where the mast arrangement is deployed. As such, the operator must remain near the vehicle when deploying the mast and return to the vehicle to adjust the mast or accessory as conditions or needs at the deployment site change. Accordingly, it would be beneficial to allow the operator to deploy and manipulate the mast and accessory while at a distance from the vehicle without requiring an extended cord stretching back to the vehicle.

The prior art has made progress toward overcoming the disadvantages discussed above. The prior art discloses an extendable mast arrangement with a control system that utilizes a wireless remote control for the input of command signals by an operator. The remote control transmits the command signals to the mast arrangement using a suitable electromagnetic wave. One disadvantage of such prior art is that the communication signals between the remote control and the mast arrangement are susceptible to interference, at times rendering a mast arrangement unresponsive to the command signals from the remote control. Another disadvantage of such prior art is realized in situations where multiple mast arrangements are deployed in one area. It will be appreciated that in such a situation many or all of the mast arrangements may respond to a command signal from a remote control that was intended to adjust only one mast arrangement.

Yet another disadvantage exists in mast arrangements that use either a wired handheld control unit or a wireless handheld control unit. As mentioned previously, a wired handheld control unit limits mobility of the operator, can create trip hazards, limits visibility and convenience to the operator, etc. On the other hand, a purely wireless handheld control unit can suffer from interference or poor performance/responsiveness, or become inactive as the power source or batteries die.

As such, it would be beneficial to utilize mast control systems that employ communication signals that are less susceptible to interference, that allow for reliable performance, and optimize operator efficiency and convenience.

Thus, in accordance with the present invention, an extendable mast arrangement is provided which overcomes or minimizes the problems and difficulties encountered with the use of arrangements of the foregoing nature, while promoting and maintaining the desired simplicity of structure, economy of manufacture, and ease of operation.

### BRIEF SUMMARY OF THE INVENTION

According to one aspect of the present invention, a dual mode handheld remote control for selectively operating and communicating with an associated mast arrangement in one of a wired or a wireless mode is provided. The remote control includes a housing and a controller disposed internally to the housing. The controller includes a wireless communication mode for wirelessly communicating with the mast arrangement and a wired communication mode for communicating with the mast arrangement via a wired connection. An input device is secured to the housing and is operatively connected to the controller. The input device is responsive to an associated command selected by an associated operator and relays the associated command to the controller for controlling the associated mast arrangement. A power source is provided for powering the remote control.

According to another aspect of the present invention, an adjustable telescopic mast arrangement for supporting and controlling an associated mast accessory is provided. The arrangement includes a mast base including a mast assembly having a plurality of telescopic mast sections. The mast assembly is pivotally attached to the base and supports the associated mast accessory. The mast assembly includes a stowed position and an extended position. A base controller is operatively connected to the mast base for raising and lowering the mast assembly. A mast accessory controller is operatively connected to the associated mast accessory for controlling at least one function of the associated mast accessory. A dual mode handheld remote control for controlling the mast base and the mast accessory is provided. The remote control receives an associated command from an associated operator and transmits the associated command to one of the base controller or the mast accessory controller in either of a wired communication mode or a wireless communication mode.

According to still another aspect of the present invention, a method for controlling an adjustable telescopic mast arrangement using a dual mode handheld remote control is provided. The arrangement is capable of supporting and controlling an associated mast accessory. The method includes powering and initiating a mast base, a mast base controller, and a mast accessory controller. The dual mode handheld remote control is provided having a controller. The controller includes a wired communication mode and a wireless communication mode. The controller of the remote control is connected to the base controller such that the controller of the remote control is in communication with the mast base controller in the wired mode and selectively operates at least one function of the mast arrangement via the remote control while in the wired communication mode. At least one wireless communication parameter is negotiated while in the wired communication mode for establishing a future wireless communication connection between the remote control and the base controller. The controller of the remote control is disconnected from the base controller. The controller of the remote control switches from the wired communication mode to the wireless communication mode. A wireless communication is established between the remote control and the base controller using the previously negotiated at least one wireless communication parameter and selectively operates at least one function of the mast arrangement via the remote control while in the wireless communication mode.

### BRIEF DESCRIPTION OF THE DRAWINGS

The foregoing objects, and others, will in part be obvious and in part pointed out more fully hereinafter in conjunction with a written description of preferred embodiments of the invention illustrated in the accompanying drawings, in which:

FIG. 1 is a side view of a first embodiment of an extendable mast arrangement in accordance with the present invention, including a dual mode remote control for transmitting command signals to a base and a mast accessory of the mast arrangement in a first or wireless mode;

FIG. 2 is a side view of the extendable mast arrangement of FIG. 1, showing the dual mode remote control transmitting command signals to the base and the mast accessory (via the base) in a second or wired mode;

FIG. 3A is a front view of the dual mode remote control of FIG. 1 illustrating a keypad, a display, and a communications cable attached to the dual mode remote control;

FIG. 3B is a side view of the dual mode remote control of FIG. 1 illustrating the communications cable detached from the dual mode remote control;

FIG. 3C is an enlarged view of the keypad of the dual mode remote control of FIG. 3A illustrating a plurality of functions;

FIG. 4 is a schematic diagram of the command encoder and transmitter of the dual mode remote control of FIG.1;

FIG. 5 is a schematic diagram of the control system in the base of the extendable mast arrangement of FIG. 1;

FIG. 6 is a schematic diagram of the control system adjacent mast accessory of FIG. 1;

FIG. 7 is a perspective view of a second embodiment of a pneumatically telescopic mast arrangement in accordance with the present invention, in a stowed or nested state, including a dual mode remote control for transmitting command signals to a base and a mast accessory of the mast arrangement in a first or wireless mode;

FIG. 8 is a side view of the second embodiment of the pneumatically telescopic mast arrangement, in accordance with the present invention, in a partially extended state, illustrating the dual mode remote control transmitting command signals to a base and a mast accessory of the mast arrangement in a second or wired mode;

FIG. 9 is a side elevational view of the mast illustrating a current monitor and control logic;

### DETAILED DESCRIPTION OF THE INVENTION

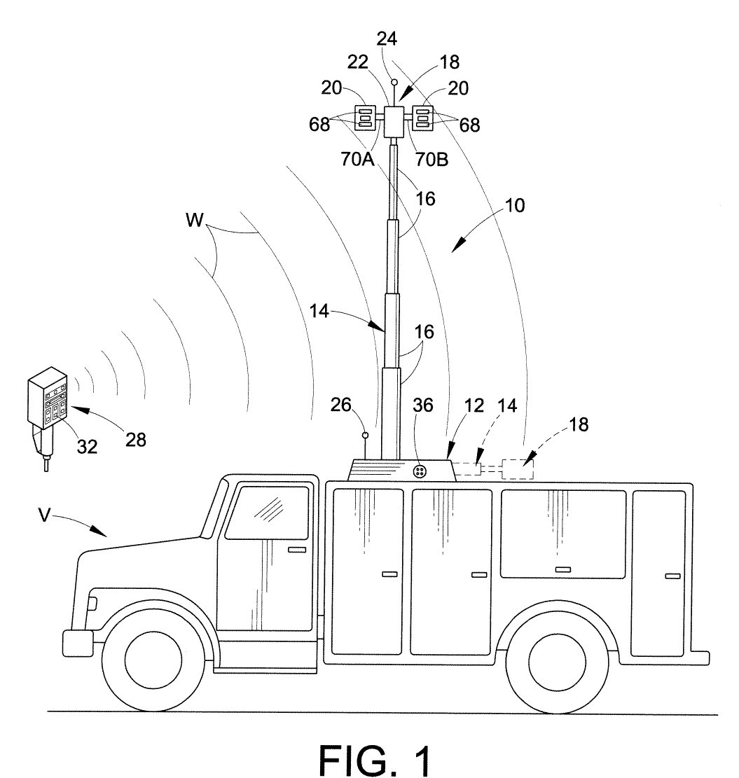

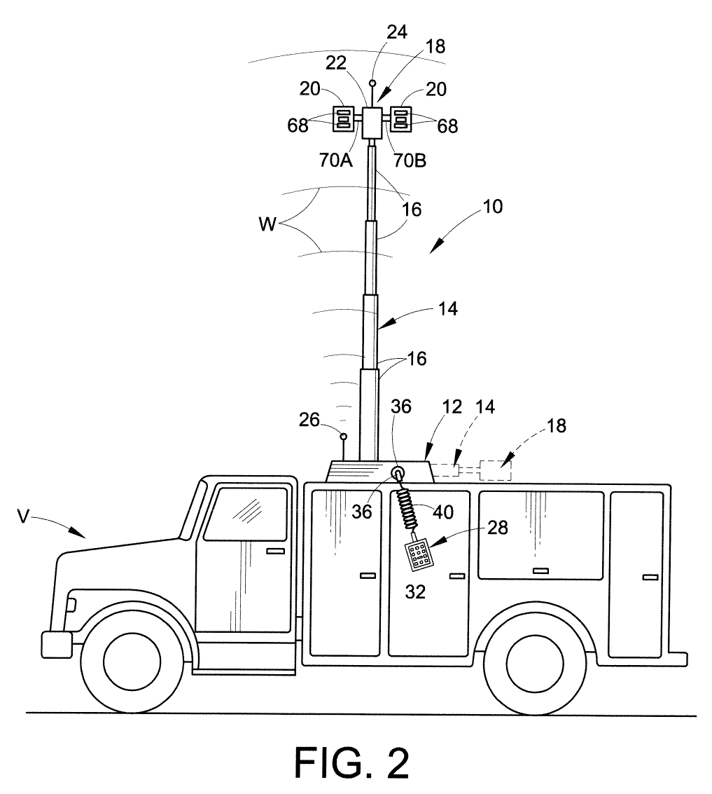

Referring now in greater detail to the drawings, wherein the showings are for the purpose of illustrating preferred embodiments of the invention only, and not for the purpose of limiting the invention, FIGS. 1 and 2 of the drawings illustrate a mobile vehicle V supporting a first embodiment of an extendable mast arrangement 10. A base 12 of arrangement 10 pivotally supports a telescopically extendable mast 14 which is comprised of a plurality of mast sections 16. Mast 14 is pivotally supported on base 12. Mast 14 supports a mast accessory, such as light 18, at the end opposite base 12. Light 18 includes light housings 20 and controller housing 22. It will be appreciated that mast 14 may support one or more of a wide variety of accessories, such as cameras, microphones, and loudspeakers, for example. The subject embodiment utilizes light 18 as one illustration of a mast accessory, and is in no way intended as a limitation with regard to type of accessories supportable on mast 14.

The first embodiment of the mast arrangement 10 includes a control system that will be discussed in detail hereinafter. The components of the control system that are visible in FIGS. 1 and 2, include accessory antenna 24 extending from controller housing 22, base antenna 26 extending from base 12, a handheld dual mode remote control 28, and a remote control to base hard-wire connection receptacle 36 supported on base 12. It will be appreciated, and more fully discussed hereinafter, that the control system of mast arrangement 10 includes various subsystems located in different parts of the mast arrangement. By way of example, a mast control subsystem can be located in base 12 and a light control subsystem can be located in controller housing 22. Base antenna 26 and receptacle 36 are in electrical communication with the mast control subsystem on base 12, and accessory antenna 24 is in electrical communication with a light control subsystem on controller housing 22.

FIGS. 1 and 2 illustrate the utilization of two different interface/communication modes for the input of control commands by an operator using the handheld dual mode remote control 28. In FIG. 1, an operator manipulates a plurality of control keys 32 of wireless remote control 28 to input control commands corresponding to the desired movement of mast 14 and/or light 18. In a first or wireless mode, remote control 28 converts the control commands to encoded command signals (in a manner later described in greater detail) and then transmits the commands as electromagnetic waves W. Antennas 24 and 26 receive waves W, which are then decoded from command signals into control commands to which the mast control subsystem and accessory control subsystem are responsive. It will be appreciated that electromagnetic waves W output by remote control 28 will include control commands for both the functions and movements of light 18 as well as those of mast 14. As such, in the first embodiment, both the light control portion of the control system and the mast control portion of the control system will, at times, receive command signals that are directed toward a different portion of mast arrangement 10. That is, the light control portion of the control system will receive and decode command signals directed toward the mast control portion of the control system and vice versa. As such, the command signals are filtered out by the microprocessor and directed to the appropriate portion of the control system.

In FIG. 2, the dual mode handheld remote control 28 is shown operating in a second or wired mode. The wired mode involves connecting remote control 28 to receptacle 36 in the base 12. In much the same manner as depicted in FIG. 1, an operator manipulates control keys to input control commands corresponding to the desired movement or function of mast 14 and/or light 18. Remote control 28, through cord 40, plug 38, and receptacle 36, communicates with the mast control subsystem in base 12. As in the first or wireless mode, not all of the control commands communicated to the mast control subsystem from the remote control 28 are intended for controlling the mast. When operating in the second or “wired” mode, some control commands will be instructions intended for the accessory control subsystem that will be relayed to the accessory control subsystem via the mast control subsystem. Accordingly, the mast control subsystem is also adapted to convert the control commands received from remote control 28 into encoded command signals which are transmitted through base antenna 26 as electromagnetic waves W. Accessory antenna 24 receives waves W, which are then decoded as previously discussed with respect to FIG. 1, and the accessory control subsystem responds accordingly by adjusting light 18 or other accessory. In this way, the accessory control subsystem can receive any and all control commands without the need for an electrical communication cable extending along mast 14 from base 12 to controller housing 22.

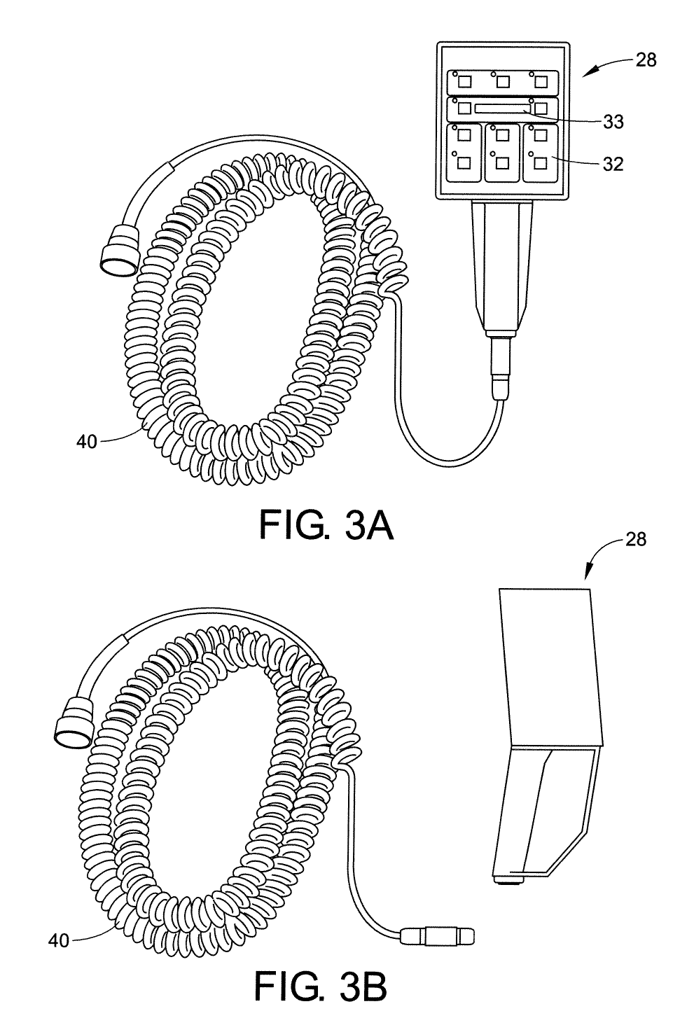

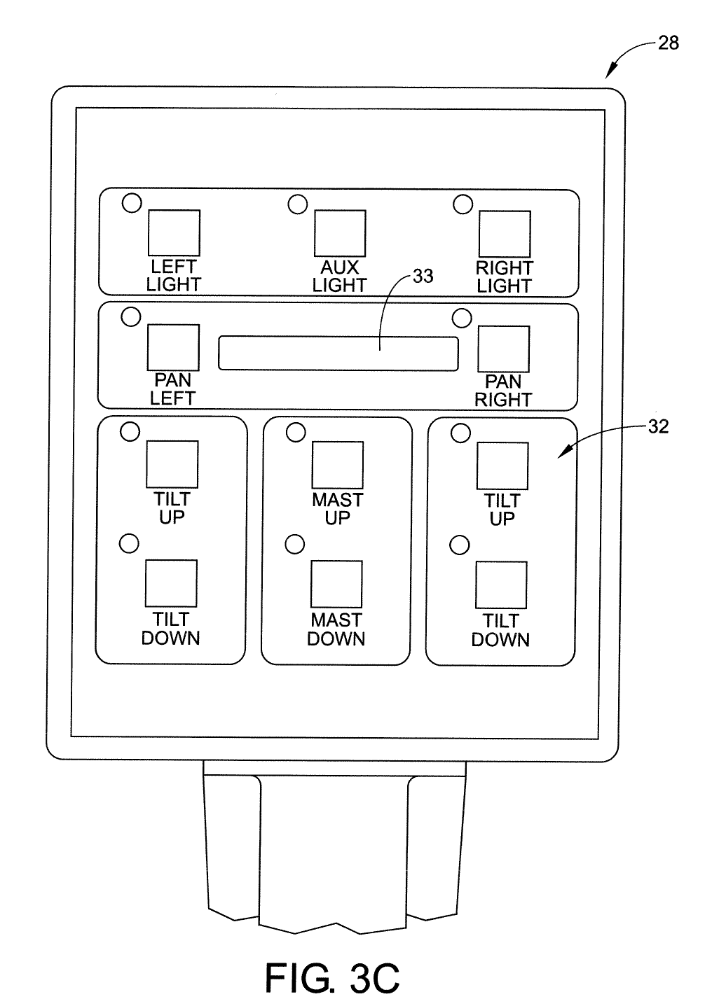

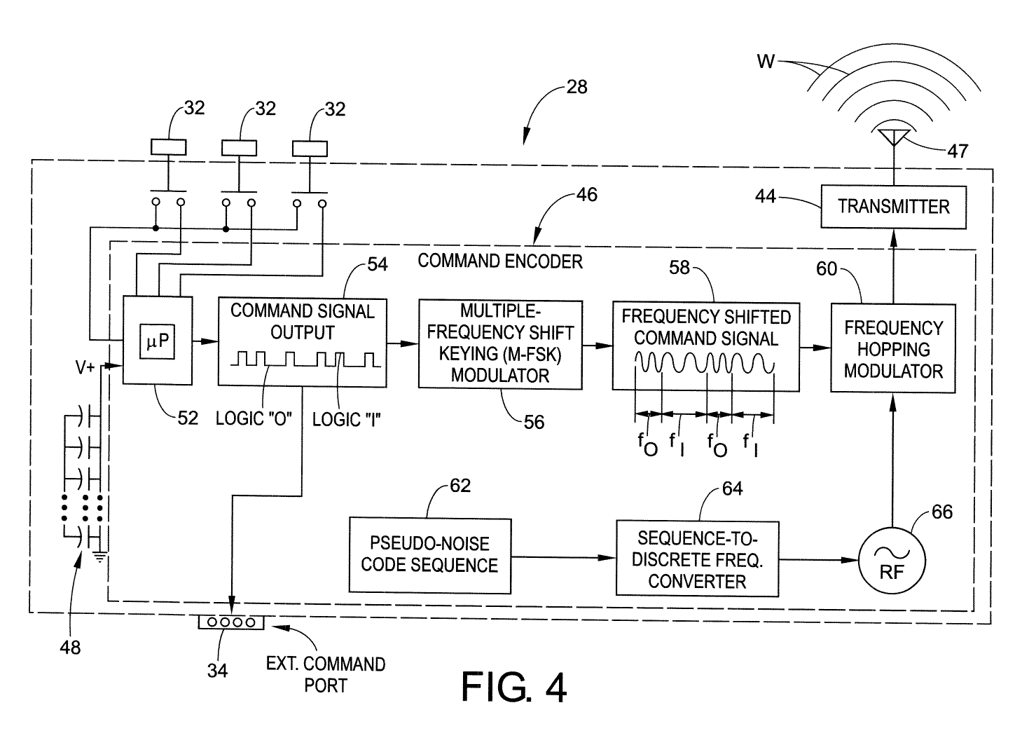

Remote control 28, as is further shown in FIGS. 3A-4, includes a plurality of control keys 32, a display 33, an external communications port 34, a command encoder 46, a transmitter 44, an internal remote antenna 47, and a self-contained power source 48, such as a rechargeable battery or a capacitive energy power source. The capacitive energy source (i.e., a plurality of high Farad capacitors or “Supercaps”) may be connected in series and or parallel configurations to obtain the level of energy storage needed to power the remote control 28. Using capacitors or “supercaps” as a primary power source has several advantages. For example, “Supercap” storage devices can be used in place of batteries so as to avoid the pitfalls typically associated with both rechargeable and non-rechargeable batteries. For one, supercaps do not develop adverse discharge patterns and do not create a “memory” which reduce charge capacity. Furthermore, complete discharge patterns do not reduce capacity and supercaps are more environmentally friendly by comparison to rechargeable/non-rechargeable battery chemistries.

The Supercaps can be soldered to a PCB located in the bottom of the handheld. The supercaps can be in the 10's of Farads range having a low voltage. In such a circumstance, the supercaps can be connected in series to meet the requisite voltage level. Charging occurs whenever the wireless handheld is connected to the base in the “wired” mode. However, the actual unit itself does not need to be powered-up. There is an intelligent board in between that is powered fulltime. If a wireless handheld does discharge to the point it cannot be used, it becomes immediately useable when plugged in for wired operation.

As one of the control keys 32 is depressed, a corresponding electrical signal causes microprocessor 52 to execute the desired function of the depressed control key. An example of functions that could be available to the operator for powering the lights and movement of the mast of the first embodiment include: Pan Left, Pan Right, Left Lights (toggles on and off), Auxiliary Lights (toggles on and off), Right Lights (toggles on and off), Left Tilt Up, Mast Up, Right Tilt Up, Left Tilt Down, Mast Down, and Right Tilt Down. As will be further described hereinafter, when the remote control 28 is operating in the wireless mode, command encoder 46, including microprocessor 52, outputs an encoded command signal that corresponds to the operator's input to transmitter 44 which broadcasts the encoded command signal as electromagnetic waves W via remote antenna 47. It will be appreciated that control keys 32 may be replaced with any suitable input device, such as a membrane pad, touch sensitive/scroll pad, or a touch-screen. Alternately, if the remote control 28 is operating in the wired mode, the microprocessor 52 outputs a command signal that is received directly by the base or mast control subsystem via the external communications port 34.

Turning now to the encoding and transmitting portion of the remote control, any number of techniques may be employed for avoiding RF interference. For example, frequency hopping spread spectrum modulation (FHSS), direct sequence spread spectrum (DSSS), and or amplitude shift keying (ASK) can be used. These forms of spread spectrum modulation (SSM) are typically used to convert a narrow bandwidth signal susceptible to interference and interception into a wide bandwidth encoded signal that is difficult to intercept and which is minimally affected by interference. Spread spectrum modulation, including FHSS, DSSS, ASK and other modulation techniques, is a common and well understood technology.

As illustrated in FIG. 4, and by way of example only, a FHSS type SSM circuit may include a command encoder comprised of a microprocessor 52, a multiple-frequency shift keying modulator 56, a frequency hopping modulator 60, a pseudo-noise code sequence 62, a discrete frequency converter 64, and a carrier wave generator 66. These components cooperate to convert a binary command signal 54 to a frequency-shifted analog command signal 58. The carrier wave and frequency-shifted command signal are combined by the modulator 60 to form an encoded command signal which is output to a transmitter 44 and broadcast as electromagnetic waves W. A pseudo-noise code sequence is fed into converter 64 and each element of the sequence is converted to or correlated with a discrete hopping frequency within the frequency band utilized by converter 64. After a specified time, converter 64 will use the next element in the noise code sequence to determine the next hopping frequency. This process continues for each code/element of the pseudo-noise code sequence. Thereafter, the sequence will repeat. As noted previously, and as will be discussed in greater detail below, DSSS, ASK, or other types of SSM techniques could be used in the coding and decoding of command signals of the instant invention. Naturally, the appropriate component substitutions would be made in the command encoder 46 (FIG. 4) and the corresponding command decoders of the system in order to accommodate a given SSM technique.

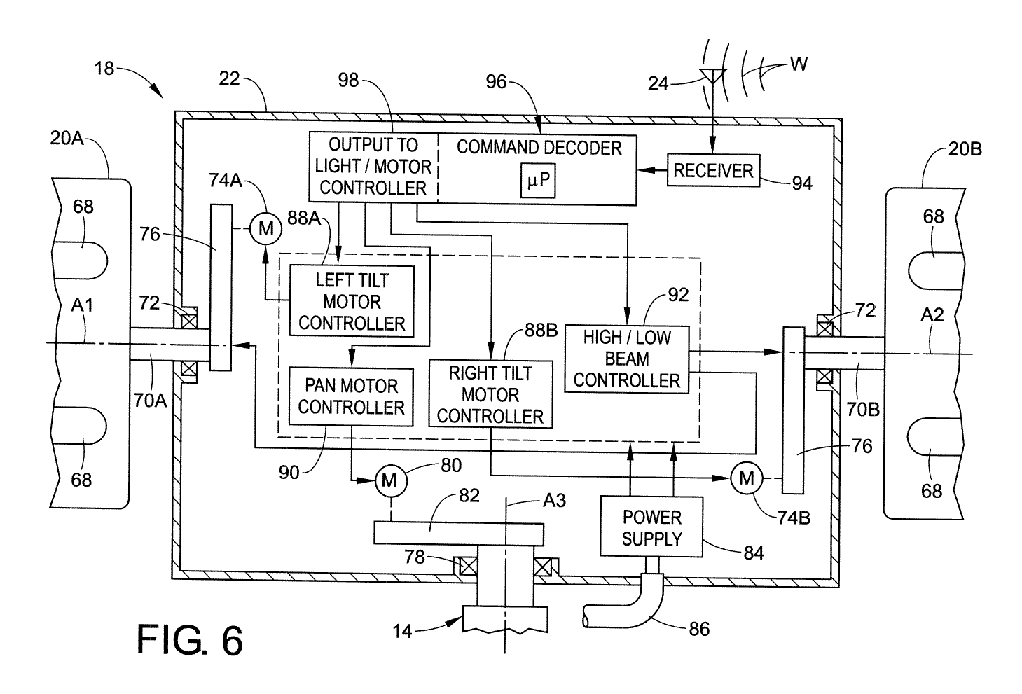

With reference now to FIG. 6, the mast accessory or light 18 is shown as having a controller housing 22 supported on the end of mast 14. Controller housing 22 supports a left light housing 20A and a right light housing 20B each of which has two light sources 68. Light housings 20A and 20B are respectively supported on shafts 70A and 70B which are supported by bearings 72 of controller housing 22. Shaft 70A supports left light housing 20A and defines an axis A1. Shaft 70A is driveably connected to left tilt motor 74A by belt 76, such that shaft 70A and housing 20A are rotatable around axis A1. Similarly, shaft 70B supports light housing 20B and defines an axis A2. Shaft 70B is driveably connected to right tilt motor 74B by belt 76 such that shaft 70B and housing 20B are rotatable around axis A2. Controller housing 22 is supported at the end of mast 14 by bearing 78.

Mast 14 defines an axis A3 about which light 18 rotates on bearing 78. Mast 14 is stationery, a pan motor 80 generates rotational output which is transmitted to mast 14 through belt 82. In response to the output of motor 80, light 18 pans about axis A3 of the stationary mast 14. Controller housing 22 supports a power supply 84 which receives electricity through wire 86 from a power source at the opposite end of mast 14 adjacent the vehicle. Controller housing 22 also supports a left tilt motor controller 88A and a right tilt motor controller 88B. Controllers 88A and 88B respectively communicate with tilt motors 74A and 74B to independently direct light housings 20A and 20B. Light sources 68 which are supported by light housings 20A and 20B are illuminated and extinguished in response to signals from beam controller 92. Pan motor controller 90 communicates with pan motor 80 to rotate light 18 about axis A3 of mast 14 as previously discussed.

Controller housing 22 also supports accessory antenna 24, receiver 94, command decoder 96, and command output 98. Receiver 94 receives control commands from remote control 28, in the form of electromagnetic waves W, through accessory antenna 24. Receiver 94 converts the electromagnetic waves into encoded command signals which are fed into command decoder 96. The encoded command signals are decoded by command decoder 96 and output by command output 98 to controllers 88A, 88B, 90, and 92. In operation, receiver 94 receives electromagnetic waves W and converts those waves into encoded command signals which are electrically transmitted to command decoder 96. The encoded command signals are decoded by command decoder 96 into control commands corresponding to the movements and functions of light 18, in accordance with the operator's commands input into remote control 28. Command decoder 96 directs corresponding control commands to command output 98 which feeds these control commands to the appropriate controller, which in turn responds by activating or deactivating the appropriate component.

Decoding the encoded command signal is essentially the reverse of the encoding process. In the first embodiment, the encoded command signals are received from receiver 94 by a frequency hopping correlator. The correlator converts the signal into a frequency shifted command signal using a carrier wave that is cooperable with the carrier wave used to encode the command signal from remote control. The cooperable carrier wave is generated based on a pseudo-noise code sequence that is identical to the code sequence during encoding. Thereafter, the correlator outputs a frequency shifted command signal that is fed into a multiple-frequency shift keying demodulator which converts the resulting analog, frequency-shifted command signal into binary command signal. The command signal is then fed into a microprocessor which directs those control commands to the controllers for the mast or mast accessories.

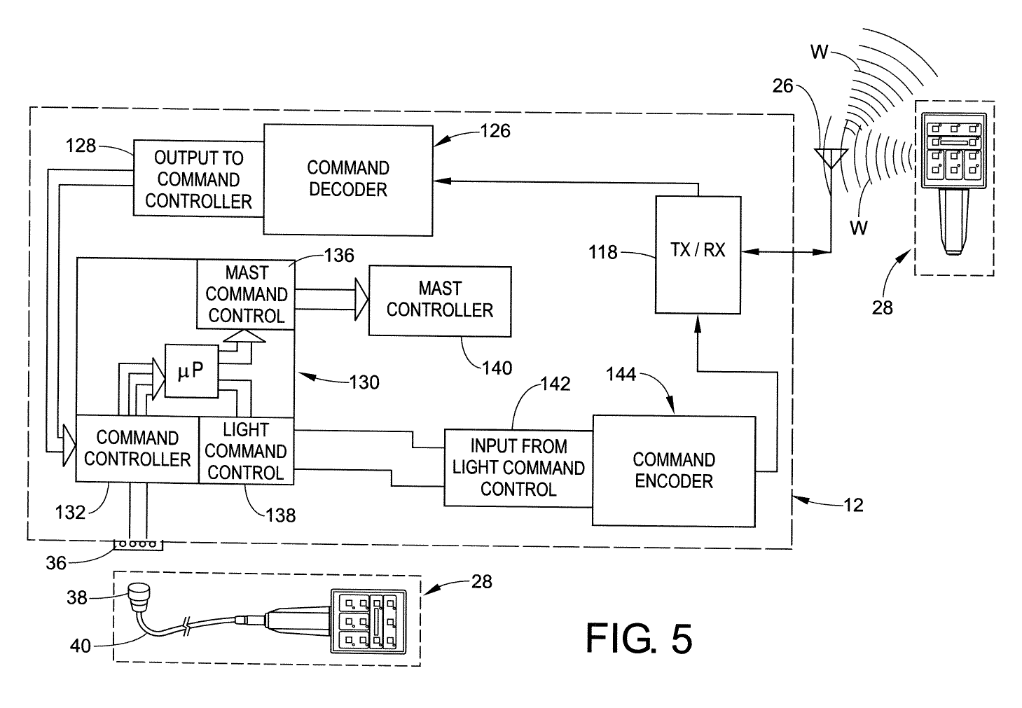

As shown in FIG. 1, remote control 28 outputs electromagnetic waves W that are received by accessory antenna 24 and base antenna 26. FIG. 5 is a schematic diagram illustrating a portion of the control system of mast arrangement 10 that is located in base 12. Extending from base 12 is base antenna 26 which is in selective electrical communication with a transceiver 118. In FIG. 5, the plug 38 of cable 40 is inserted into receptacle 36, the wired mode is triggered and command signals are sent directly to the command controller bypassing the transceiver 118 and decoder/encoder 126,144, entirely. When the plug 38 is removed, the microprocessor detects this and wireless mode is reestablished in a manner explained in more detail below.

It will be appreciated, that the transceiver 118, command decoder 126 and command output controller 128 will operate in a manner substantially similar to that described for FIG. 6 regarding the operation and responsiveness of light 18 to the commands from remote control 28 when operating in the wireless mode. Accordingly, transceiver 118 receives electromagnetic waves W from remote control 28 through base antenna 26 and across terminals 122 of switch 116. Transceiver 118 converts the electromagnetic waves into encoded command signals that are electrically transmitted to command decoder 126. The encoded command signals are decoded by decoder 126 and control commands are electrically output to command output controller 128. Microprocessor 130 includes a plurality of input and output terminals, including command controller input terminal 132, mast command control output 136, and light command control output 138. Control commands are fed into command controller input 132 of microprocessor 130 by either command output controller 128 (in wireless mode) or via receptacle 36 (in wired mode). Microprocessor 130 processes the control commands input by controller 128 and outputs the corresponding control commands to mast controller 140 which is adapted to control the movements and functions of the mast. Light command input control 142, command encoder 144, and transmitter 120 may not take an active role in processing command signals when mast arrangement 10 is operating according to FIG. 1.

When in wired mode, as is shown in FIG. 2, an operator utilizes remote control 28 to input control commands directing the movement and functions of mast 14 and light 18. Control commands are communicated directly to microprocessor 130 via cable 40 (e.g., an RS-485 serial link), etc. without the need for transmitting control signals as electromagnetic waves. Accordingly, as microprocessor 130 recognizes the presence of remote control 28 at command controller input 132, the base unit/mast controller subsystem to switch from a receiving station to a transmitting station. Mast control commands from wired mode are processed by microprocessor 130 and communicated to mast controller 140 through mast command control output 136. Light control commands are also input through remote control 28 in wired mode and processed by microprocessor 130 and communicated to light command input control 142 through light command control output 138. The control commands are then fed into command encoder 134 which outputs an encoded command signal to transmitter 120. The transmitter converts the electrical, encoded command signals into electromagnetic waves that are broadcast by base antenna 26 as electromagnetic waves W.

As discussed previously, the first embodiment may employ frequency hopping spread spectrum (FHSS) modulation. However, other spread spectrum communication techniques could be employed. For example, Direct Sequence Spread Spectrum (DSSS) (e.g., ZigBee technology) is a very robust encoding technique and could be used in place of FHSS. In the case of DSSS, the various controllers (remote control, base/mast controller, mast accessory controller, etc.) of the mast arrangement attempt to negotiate a suitable wireless communications link by attempting different frequencies under a controlled algorithm until they are able to establish communication. While, DSSS is not as secure as FHSS, security is not as big of a concern since media access control (MAC) address filtering can be employed. Thus, since each controller component of the mast arrangement could include a unique MAC address and once the controllers recognize or are programmed with the MAC addresses of the other respective components within a given system or arrangement, then only the intended controllers or components will respond when an encoded command (including the MAC address of the intended controller) is transmitted. For example, when the base or mast assembly is initiated or powered-up, any remote control that is plugged in can communicate to the base via the hardwired port to negotiate a communications partnership for communication when the remote control is in the wireless mode. Such device negotiation would include, among other things, the DSSS algorithm to be used and the exchange of the MAC addresses of each device associated with that mast arrangement. This information would then be stored in the remote control and or the base until a new partnership is negotiated with a different handheld at power-up. Once a partnership has been negotiated, it is remembered even though one or more of the remote control or mast controller/base units is powered down. As such, the partnership can be based on the unique hardware (MAC) addresses of the RF modules in the base unit and the handheld remote control. This relieves the operator of the responsibility of configuring the handheld to work with the unit while simultaneously guaranteeing that only one unit will respond to the handheld.

As described previously, the handheld control has a wired mode and a wireless mode. When the handheld is plugged in to the base unit, it “talks” through the hardwired cable (e.g. via a RS-485 serial communication link) and shuts down the wireless portion of the remote control. The remote control can transition from wired to wireless mode while in operation by simply unplugging it, and vice versa. In the wired mode, the cable connects the handheld to the mast assembly and communicates over the cable and when in the wireless mode, an RF module communicates to a similar RF module in the mast assembly, mast accessory housing, or other device associated with the mast arrangement.

Furthermore, even if a particular remote control fails during operation of the mast arrangement, or the negotiated communication partnership fails for any other reason, any other remote control can be used in place of the defective remote control by simply connecting the replacement remote control to the receptacle of the base unit (as previously described) thereby placing the replacement remote control into the “wired” mode. Thus, the replacement remote control can negotiate a new partnership and thereafter be disconnected and be used in the wireless mode.

Yet another technique for wireless communication that could be employed by the invention of the present disclosure involves Amplitude Shift Keying (ASK) technology. This technology is similar to that which is used by garage door openers and may not be as reliable. Moreover, using ASK would likely require the operator to physically configure the wireless connection at both ends by setting DIP switches.

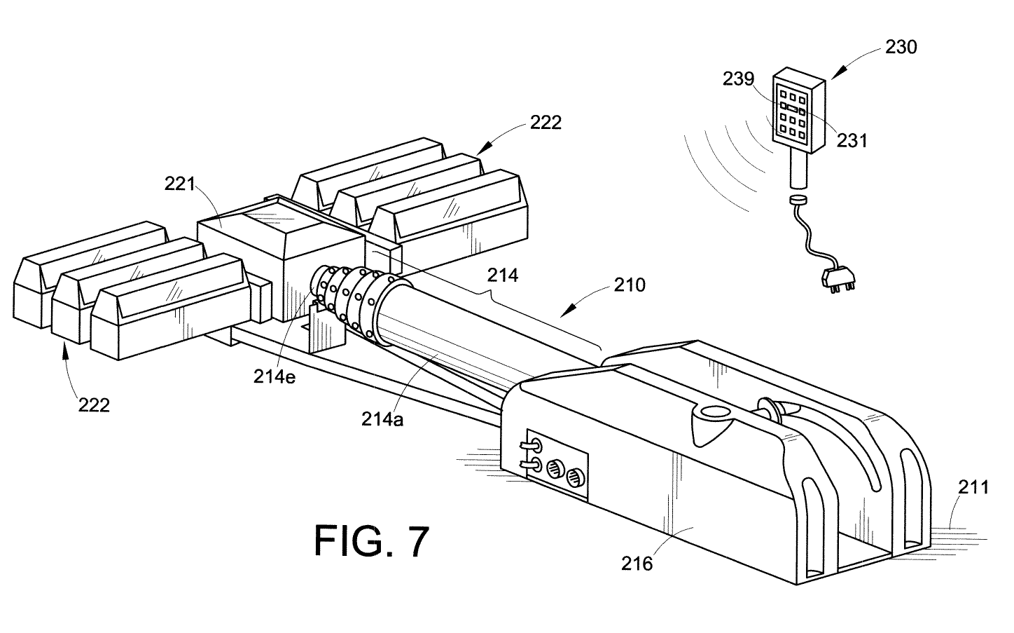

With reference now to FIG. 7, a second embodiment of a telescopic mast arrangement 210 mounted on a roof 211 of a motor vehicle 212. The mast includes a stow position and an extended position and is capable of being placed at a tilt angle between 0° and 90°. As shown in FIG. 7, telescoping mast 210 also includes nested/adjacent telescoping sections 214. The telescoping section 214a is at a lower mast end 215 of mast 210 and is pivotally mounted to the base 216 which is mounted to vehicle roof 211. Each of telescoping sections 214 are relatively rigid tubular sections facilitating the pneumatic extension and retraction of telescoping mast 210. Mounted at the upper mast end 217, at telescoping section 214e, is a positioner assembly 221 to facilitate the placement of utility lights 222 and/or cameras at upper mast end 217.

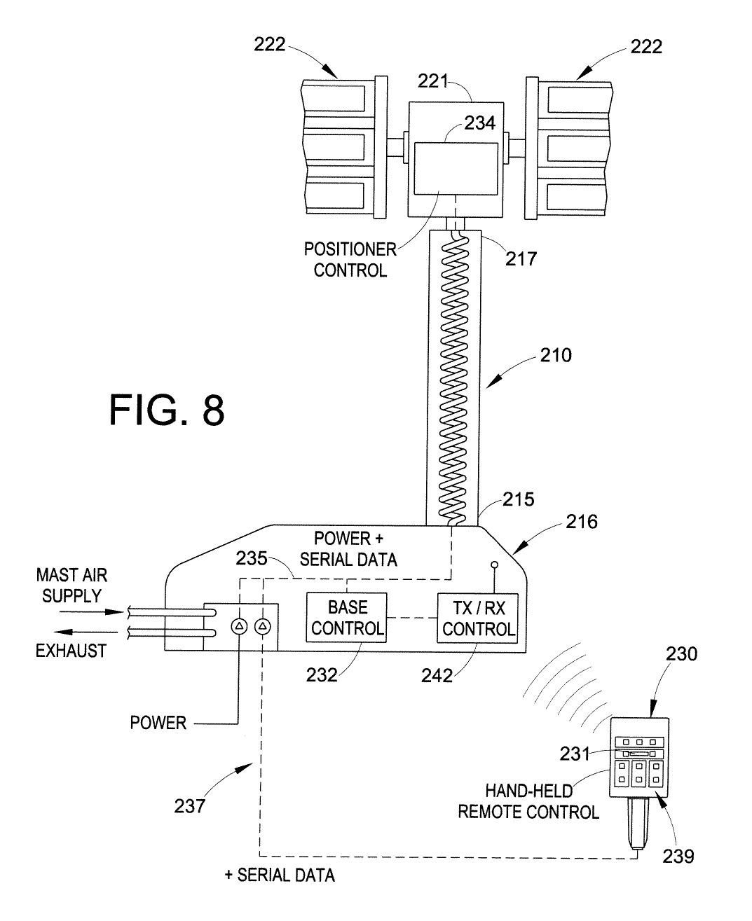

Referring now to FIG. 7-8, control of the mast positioner and lighting system is accomplished via a handheld dual mode remote control 230, a base control 232 and a mast accessory/positioner controller 234. The base control 232 utilizes a serial communications link 235 with other boards in the system to “multiplex” control data. Of course, as discussed with respect to the first embodiment, the base control 232 may communicate wirelessly (via any RF spread spectrum modulation technique such as those described previously) to the position/mast accessory control 234, and the dual mode remote control 230. If a serial link is used, it may include an RS-485 multi-drop type with settable data-loss response (set by a rocker switch to either stop or stow). Communication with the remote control can also be via a serial link 237 such as an RS-485 type link.

Switching of AC power to the lights 222 occurs via the positioner control 234. No AC power is connected to the base control board 232. AC power preferably enters the system via an environmentally sealed military connector (such as MS 3102 R24-10P) attached internally by way of a terminal strip to AC power wires of custom coiled cable imbedded within the mast. The coiled cable includes a first pair of wires that supply AC power to each of the two banks of lights 222 and also serve as a chassis ground. A second pair of wires supply DC power for operation of the positioner control 234 and connect to the base control board. Finally, a third pair of wires supply the communications line to the positioner control and will also connect to the base control board.

The base control board 232 can be set for either “night scan” or “night scan chief” operation by a computer connected to the serial link 235. This affects when the positioner control is placed in the stow mode, and whether or not the base control waits for it before lowering the mast.

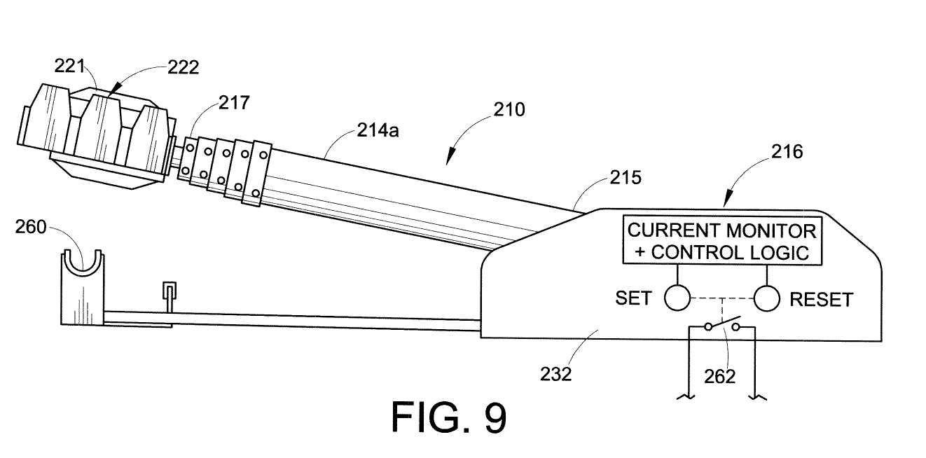

Referring now to FIG. 9, the base control 232 will also monitor current to the actuator motor and determine whether the mast is in the stowed position in cradle 260. When actuator motor current continually increases for a pre-determined time, the base control will interpret this as the stow position. Additionally, the control will monitor motor current to see if there is a sudden drop in current during nesting (indicating the inclination's motor has exceeded its internal limit switches). A limit switch indicating the mast has been fully extended or retracted could use a magnetic sensing switch, such as a reed switch. The sensing switch can indicate that the mast is at the 90° position. Current increase over the sampling period triggers power down at stow. An integrated saddle or cradle 260 reduces the required skill of the customer for installation by eliminating adjustments required for installation.

Contact closure to customer interlock circuitry is shown in FIG. 9. A bistable relay 262 maintains the correct state regardless of the unit being powered. The relay remains in an open state when the unit is not stowed. When the unit is stowed, the relay latches to a closed state. The relay serves to provide a mode for transmission or other interlock to prevent vehicle movement when the mast is not in a stowed position.

If at a “power on” position the base control determines the mast is not in its nested position and one or both communication links 235, 237 are not functioning, it will attempt to re-establish communications for a pre-defined time. If communication with the positioner control is established but communication with the hand-held remote cannot be established, then the base control will request the positioner control to stow and then nest the mast.

As in the first embodiment, the hand-held remote control 230 of the present invention offers dual mode communication between a first or wireless mode and a second or wired mode. In the wired mode, the remote control 230 utilizes a serial communications cable 237 to link to the base control and transmit “multiplex” control data. A two wire serial communications link 237 could be used to minimize the amount of wiring needed for multiple functions. The remote control 230 can also be protected against reverse voltage hook-up. A connector for connecting the mast unit to the remote control can be a bayonet environmentally sealed military connector such as an MS3106E14S-2P style connector. The cable used with the remote control can be of retractable four conductor weather proof construction. When in the wireless mode, the remote control 230 operates in generally the same manner as the control 28 of the first embodiment except that the communication between the base and the mast accessory or position controller can be via a hardwired serial data link.

The hand-held remote control 230 accepts switch activations from the operator via the key pad 239 or other input device and translates them into commands for transmission to a transceiver 242 that can be integrated or otherwise operably connected to the base control board 232. The hand-held remote control will also send, at the request of the base control board, a status message to inform the base control which switches are engaged and that it is still functioning properly. If the base control does not receive a response, for whatever reason, the base control will take appropriate action. If the hand-held remote control fails to receive a request from the base control board within a specified time period, it will light an LED display 231 with a pre-defined indication of a fault. If the operator engages a switch, the hand-held remote control will appropriately modify the status response repeatedly as long as the operator continues to engage that switch. The base control will pass along appropriate commands to the positioner controller in response to the hand-held remote control. The positioner controller will also send status responses upon request to the base control board to let it know it is functioning properly. If an error status message is received or no message is received from the positioner controller, the base control board will pass that information on to the hand-held remote control for interpretation for the fault display. Additionally, various states of the system will be passed to the hand-held remote control so that status LEDs can give proper indication of the state of the system. Fault codes could indicate the specific board (or unit number), and the specific fault associated therewith. Examples of base control board fault messages that could be presented include: communication timeout, communication fault, initiate pushbutton, EEPROM life, and saddle location. Examples of positioner control fault messages that could be presented include: pan limit overlap, left tilt limit stuck, right tilt limit stuck, pan limit stuck, communication timeout, communication fault, left tilt up limit, left tilt down limit, right tilt up limit, right tilt down limit, pan right limit, pan left limit, left tilt limit overlap, and right tilt limit overlap. Examples of hand-held remote board fault messages that could be presented include: communication timeout, communication fault, and internal communication fault.

It should also be noted that, mast arrangements of the above discussed embodiments can function in one of two modes. In either mode, separate cycle counters keep track of cycles in each mode. In a first or National Fire Protection Association (NFPA) power down compliance mode, the unit disconnects itself from power when it has nested. In order for the system to be restarted, a switch or other control must be manually reset, thus preventing accidental or unintentional activation of the mast system due to mishandling of the remote, etc. In a second mode, the mast arrangement does not disconnect itself from power once it has nested. Thus the mast arrangement in this mode is capable of erecting with accidental activation of the handheld remote control. Moreover, the mast arrangement can also monitor current through a lookup light or lamp and limit behavior of the mast arrangement when the lookup light or lamp is burned out. The lookup light is used to illuminate a space associated with the mast arrangement (e.g., the mast accessory and or the area above the mast accessory) so as to permit the operator to see any potential obstructions (e.g., power lines, tree limbs, etc.) while operating the mast. Per NFPA compliance guidelines, a lookup light is required. Thus, mast behavior can be automatically limited upon detection of a lookup light malfunction (either via a current sensor or other technique).

It will be appreciated that the above-disclosed exemplary embodiments and other features and functions, or alternatives thereof, may be desirably combined into a variety of different systems or applications. Also, presently unforeseen or unanticipated alternatives, modifications, variations or improvements therein may be subsequently made by those skilled in the art which are also intended to be encompassed by the following claims. It is thus intended that the exemplary embodiments be construed as including all such modifications and alterations insofar as they come within the scope of the appended claims or the equivalents thereof.

1. A dual mode handheld remote control for selectively operating and communicating with an associated mast arrangement in one of a wired or a wireless mode, the remote control comprising:
a housing;
a controller disposed internally to the housing, the controller including a wireless communication mode for wirelessly communicating with the mast arrangement and a wired communication mode for communicating with the mast arrangement via a wired connection;
an input device secured to the housing and operatively connected to the controller, the input device being responsive to an associated command selected by an associated operator and relaying the associated command to the controller for controlling the associated mast arrangement; and
a power source for powering the remote control.

2. The remote control of claim 1, wherein the controller includes one of a direct sequence spread spectrum encoder, a frequency hopping spread spectrum encoder, or an amplitude shift keying command encoder for encoding the associated command.

3. The remote control of claim 1, wherein the controller switches from the wired communication mode to the wireless communications mode upon the selective disengagement of the wired connection between the remote control and the mast arrangement.

4. The remote control of claim 1, wherein the power for the power source is derived substantially from at least one capacitor when the remote control is operating in the wireless communications mode.

5. The remote control of claim 1, further comprising a display operatively connected to the controller for displaying one or more of a selected command, a fault code, or a remaining power level.

6. An adjustable telescopic mast arrangement for supporting and controlling an associated mast accessory, the arrangement comprising:
a mast base including a mast assembly having a plurality of telescopic mast sections, the mast assembly being pivotally attached to the base and supporting the associated mast accessory, the mast assembly including a stowed position and an extended position;
a base controller operatively connected to the mast base for raising and lowering the mast assembly;
a mast accessory controller operatively connected to the associated mast accessory for controlling at least one function of the associated mast accessory; and
a dual mode handheld remote control for controlling the mast base and the mast accessory, the remote control receiving an associated command from an associated operator and transmitting the associated command to one of the base controller or the mast accessory controller in either of a wired communication mode or a wireless communication mode.

7. The arrangement of claim 6, wherein the remote control further includes a controller, the controller having one of a direct sequence spread spectrum encoder, a frequency hopping spread spectrum encoder, or an amplitude shift keying encoder for encoding and transmitting the associated command.

8. The arrangement of claim 6, wherein the remote control transmits the associated command via the wired mode when a communications cable is selectively engaged between the remote control and one of the base or mast accessory controller, and wherein the remote control transmits the associated encoded command via the wireless mode when the communications cable is selectively disengaged.

9. The arrangement of claim 8, wherein the remote control transmits the associated command in the wired mode over a RS-485 serial link.

10. The arrangement of claim 6, wherein the remote control further includes a power source derived substantially from at least one capacitor when the remote control is operating in the wireless mode.

11. The arrangement of claim 6, wherein the remote control further includes a display for displaying one or more of a selected command, a fault code, or a remaining power level.

12. The arrangement of claim 6, wherein the base controller and the mast accessory controller communicate via a serial link.

13. The arrangement of claim 6, wherein the base controller includes a power down stow mode based upon a mast actuator motor current, the power down stow mode requiring a manual reset by the associated operator prior to reactivating the arrangement.

14. The arrangement of claim 8, wherein the remote control, the base controller, and the mast accessory controller include unique MAC addresses.

15. The arrangement of claim 14, wherein the remote control and the base controller exchange MAC address information and negotiate parameters for establishing a wireless communication connection.

16. The arrangement of claim 6, further including a lookup light for illuminating a space associated with the arrangement and a lookup light malfunction sensor operably connected to the lookup light and at least one of the base or mast accessory controllers, wherein the base or mast accessory controller limits the motion of the arrangement when a lookup light malfunction is detected.

17. A method for controlling an adjustable telescopic mast arrangement using a dual mode handheld remote control, the arrangement capable of supporting and controlling an associated mast accessory, the method comprising:
powering and initiating a mast base, a mast base controller, and a mast accessory controller;
providing the dual mode handheld remote control having a controller, the controller including a wired communication mode and a wireless communication mode;
connecting the controller of the remote control to the base controller such that the controller of the remote control is in communication with the mast base controller in the wired mode and selectively operating at least one function of the mast arrangement via the remote control while in the wired communication mode;
negotiating at least one wireless communication parameter while in the wired communication mode for establishing a future wireless communication connection between the remote control and the base controller;
disconnecting the controller of the remote control from the base controller;
switching the controller of the remote control from the wired communication mode to the wireless communication mode; and
establishing wireless communication between the remote control and the base controller using the previously negotiated at least one wireless communication parameter and selectively operating at least one function of the mast arrangement via the remote control while in the wireless communication mode.

18. The method of claim 17, wherein the step of negotiating at least one communication parameter includes transmitting a first MAC address of the base controller to the controller of the remote control and transmitting a second MAC address of the controller of the remote control to the base controller.

19. The method of claim 17, wherein the step of switching the controller of the remote control from a wired communication mode to a wireless communication mode occurs automatically and substantially simultaneously when the remote control is disconnected from the base controller when in the wired communication mode.

20. The method of claim 17, wherein the step of establishing wireless communication further includes encoding the wireless communication between the controller of the remote control and the base controller using one of a direct sequence spread spectrum encoder, a frequency hopping spread spectrum encoder, or an amplitude shift keying encoder.

21. The method of claim 17, wherein the step of establishing wireless communication further includes transmitting one of a mast arrangement status, fault code, or mast position information and displaying the information on a display of the remote control.
